(19) United States
(12) Patent Application Publication
(10) Pub. No.: US 2014/0295076 A1
(43) Pub. Date: Oct. 2, 2014

(54) LOW SEAL INITIATION LID FOR RIGID SUBSTRATES

(71) Applicant: TORAY PLASTICS (AMERICA), INC., N. Kingstown, RI (US)

(72) Inventors: Roberto SIU, Providence, RI (US); Scott NARKEVICIUS, South Kingstown, RI (US); Jon Ian MONTCRIEFF, Foxborough, MA (US)

(21) Appl. No.: 14/303,498

(22) Filed: Jun. 12, 2014

Related U.S. Application Data
(62) Division of application No. 13/776,218, filed on Feb. 25, 2013.
(60) Provisional application No. 61/618,516, filed on Mar. 30, 2012.

(51) Int. Cl. B65D 43/02; B29C 47/06

(52) U.S. Cl. CPC B65D 43/02; B29C 47/065
USPC 427/208.2; 264/173.19

(57) ABSTRACT

A polyolefin-based heat sealable and peelable lidding film. The peelable seal films comprise from 5 to 95 percent by weight of a polyolefin based plastomer or elastomer and from 5 to 95 percent by weight of a second plastomer or elastomer. The invention also relates to methods of making and using the heat sealable, peelable seal films, having improved low seal initiation temperature.

### CROSS-REFERENCE TO RELATED APPLICATIONS

This application is a divisional of U.S. patent application Ser. No. 13/776,218, filed on Feb. 25, 2013, which claims the benefit of U.S. Provisional Application Ser. No. 61/618,516, filed Mar. 30, 2012, the entirety of which is incorporated herein by reference.

### FIELD OF THE INVENTION

This invention relates to polyolefin-based heat sealable and peelable seal films. This invention also relates to methods of making and using heat sealable and peelable seal films, especially as lidding articles to rigid substrates.

### BACKGROUND OF THE INVENTION

Heat sealable and peelable films (also referred to herein as “peelable seals”) are employed on a large scale for temporarily closing containers that include, for example, food products or medical devices. Many lidding products provide peelable performance, but sealing conditions need to be hot enough to allow for the interface to soften and create a functional seal.

Besides adequate seal strength, it is also desirable to have a low heat seal initiation temperature which helps to ensure fast packaging line speeds and a broad sealing window which could accommodate variability in process conditions, such as pressure and temperature. A broad sealing window also enables high speed packaging of heat sensitive products, as well as, provides a degree of forgiveness for changes in packaging or filling speeds.

In addition to the “sealable” characteristic, this film should also have a desired “peelable” characteristic to provide an easily open seal on a package or tray. Peelability generally refers to the ability to separate two materials or substrates in the course of opening a package without compromising the integrity of either of the two. The force required to pull a seal apart is called “seal strength” or “heat seal strength” which can be measured in accordance with ASTM F88-94. The desired seal strength varies according to specific end user applications. When used in rigid package applications, such as lids for convenience items and medical devices, typical seal strengths of 1-5 pounds per inch are desirable.

Heat sealable and peelable films are generally made from one or more polymeric resins. Polybutylene has been known to produce peelable seals in ethyl vinyl acetate (EVA) sealant layers. Although the peelability of the film is improved, the heat sealable and peelable film might have unpleasant odors due to the presence of EVA. In addition to using polybutylene, some ionomers, such as SURLYN™, is mixed with EVA to produce a heat sealable and peelable film. While the film is peelable, it causes stringiness or “angel hair” upon separation of the film. Moreover, ionomers are generally expensive and may have some odor as well.

The prior art discloses various blends of polymers used to form peel seals. These blends only partially provide the full range of properties desirable for a peel seal package. For example, U.S. Pat. No. 4,252,846 discloses a blend of ethylene vinyl acetate (EVA) copolymer and high density polyethylene (HDPE). While this blend may peel, the hot tack properties are not addressed and are therefore likely to be poor. In this patent, the peel seal has a wide sealing temperature range with minimum variance in the seal value from a selected peel strength. The range is approximately plus or minus ten degrees Fahrenheit from the control sealing temperature.

A peelable film structure is described in WO 96/04178 published on Feb. 15, 1996. The film structure comprises (a) a core layer comprising an olefin polymer and a heat sealable layer comprising a blend of low density polyethylene (LDPE) and a material incompatible with the LDPE, such as an olefin polymer or co- or terpolymer of ethylene, propylene or butene. The film structure can be heat sealed to a plastic container to form the lid of the container, or to itself to form a package. It is disclosed that when used with a plastic container, the film structure can be readily peeled from the container in order to open it.

In U.S. Pat. No. 5,358,792 a heat sealable composition is described comprising (a) from about 30 to about 70 weight percent of a low melting polymer comprising a very low density ethylene based copolymer defined by a density in the range of about 0.88 g/cm³ to about 0.915 g/cm³, a melt index in the range of about 1.5 dg/min to about 7.5 dg/min, a molecular weight distribution (M_{w}/Mₙ) no greater than about 3.5 and (b) from about 70 to about 30 weight percent of a propylene based polymer.

U.S. Pat. No. 6,590,034 describes peelable seals made from a mixture of two immiscible polymers which form a continuous phase and a discontinuous phase wherein the absolute value of the shear viscosity differential of the two polymers is less than 100 percent. Although many potential materials are covered, this reference focuses on the use of homopolymer polypropylene as the discontinuous phase.

U.S. Pat. No. 7,863,383 describes a polyolefin-based heat sealable and peelable seal. The peelable seals comprise from 5 to 98 percent by weight of a propylene based plastomer or elastomer and from 2 to 95 percent by weight of a second polymer selected from the group consisting of polyethylene, polybutylene, and styrenic polymer and mixtures thereof. The invention also relates to tamper evident peelable seals. The invention also relates to methods of making and using the heat sealable, peelable seal.

### SUMMARY OF THE INVENTION

Although a number of resins systems have been employed to make a heat sealable and peelable film, there continues to exist a need for an improved cost-effective heat sealable and peelable film with desired seal strength during processing and transportation as well as during package opening by the end consumer. It is desirable that the resin system used to produce the heat sealable and peelable film has a relatively lower seal initiation temperature and a relatively broad heat sealing window. It is also desirable that the heat sealable and peelable film is relatively age-resistant and has a relatively lower coefficient of friction and good abuse resistance and toughness.

One embodiment is a lidding film including a heat sealable and peelable layer including 5 to 95 wt % of a first polyolefin based plastomer or elastomer and from 5 to 95 wt % of a second plastomer or elastomer, wherein the second plastomer or elastomer has a different density and melt index than the first polyolefin based plastomer or elastomer.

The film may have a seal strength of 1-3 lbs/, measured at 275° F., 30 psia, and 0.5 seconds dwell, when sealed to polypropylene or crystalline polyester trays. The thickness of the heat sealable and peelable layer may be between 2-100 microns. The first polyolefin based plastomer or elastomer may be a polyolefin-based plastomer with a density of between 0.84 and 0.91 gm/cubic cm based on ASTM D792 and a melt index between 3 and 10 gm/10 min, based on ASTM D1238. The first polyolefin based plastomer or elastomer may have a vicat softening point of 40-60 degree C. based on ASTM D1525. The second polyolefin based plastomer or elastomer may have a density of between 0.880 and 0.92 gm/cubic cm based on ASTM D792 and a melt index between 6 and 10 gm/10 min based on ASTM D1238. The second propylene based plastomer or elastomer may have a vicat softening point of 60-90° C. based on ASTM D1525.

The lidding film of claim 1 may further include a base layer including polyester. The base layer may have a thickness of 9-75 microns. The base layer may be uniaxially or biaxially oriented.

An embodiment of a sealed rigid substrate may include comprising a rigid substrate and the lidding film including a heat sealable and peelable layer including 5 to 95 wt % of a first polyolefin based plastomer or elastomer and from 5 to 95 wt % of a second plastomer or elastomer, wherein the second plastomer or elastomer has a different density and melt index than the first polyolefin based plastomer or elastomer. The substrate may include polypropylene, polyester, coated paperboard, or coated aluminum.

An embodiment of a method of making a lidding film may include extruding a heat sealable and peelable layer including 5 to 95 wt % of a first polyolefin based plastomer or elastomer and from 5 to 95 wt % of a second plastomer or elastomer onto a polyester base layer to form a lidding film, wherein the second plastomer or elastomer has a different density and melt index than the first polyolefin based plastomer or elastomer.

The heat sealable and peelable layer and the base layer may be coextruded. The heat sealable and peelable layer may be extrusion coated onto a preformed base layer. The heat sealable and peelable layer may be extrusion coated onto the preformed base layer at a melt temperature between 225-350° C.

### BRIEF DESCRIPTION OF THE DRAWING

FIG. 1 is a graph of max seal strength v. temperature for the example and comparative examples.

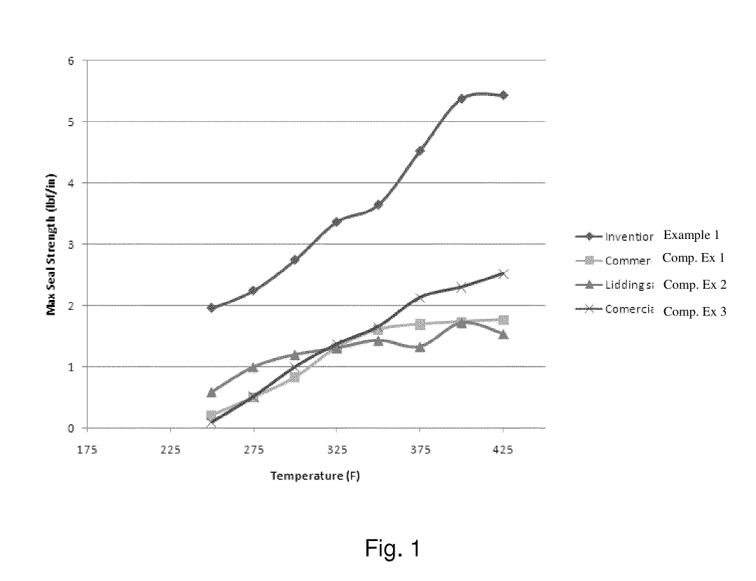

### DETAILED DESCRIPTION OF THE INVENTION

The peelable seal described in this invention is a separable joint formed between a film and a rigid substrate. This separable joint is most commonly produced by heat sealing. The mechanical resistance of the peelable seal is low enough to permit ready manual opening of the joint, i.e., without the use of any auxiliary instrument.

It has been discovered that blends from 5 to 95 percent by weight of a polyolefin based plastomer or elastomer and from 5 to 95 percent by weight of a second plastomer or elastomer (of different density and melt index), have a seal strength in the range that would make them particularly well suited for use as a peelable seal to rigid substrates like polypropylene or crystalline polyester trays, namely in the 1-3 lbs/in range, measured at 275 degrees F., 30 psia, 0.5 seconds dwell. The blend that has been developed, has shown an outstanding low seal initiation temperature as compared to other blends of similar polyolefins. This surprising discovery is disclosed here.

The pealable seal blends include at least two components, and are particularly well suited for use as a peelable lidding seal. These blends are preferably configured to be processed by extrusion coating at melt temperatures between 225-350° C., more preferably between 250-335 ° C. They can be incorporated in a monolayer or a coextruded layer, whichever best fits the extrusion coating equipment. The total thickness of this seal layer should be between 2-100 microns, preferably between 5-75 microns.

The first component in the blends is a polyolefin plastomer with a density of between 0.84 and 0.910 gm/cubic cm based on ASTM D792 and a melt index between 3 and 10 gm/10 min, based on ASTM D1238. This component will exhibit vicat softening point in the 40-60° C. range based on ASTM D1525. The seal layer may include 5 wt. % to 95 wt. % of the first plastomer, preferably 10 to 85 wt. %, or 20 to 75 wt. %.

Examples of this first component could be a variety of polyolefin plastomers such as Dow's AFFINITY KC8852G or EG8200G or most generic Polyolefin plastomers.

The second component in the blends is a different polyolefin -based plastomer than the first component that has a density of between 0.880 and 0.92 gm/cubic cm based on ASTM D792 and a melt index between 6 and 10 gm/10 min based on ASTM D1238. This second component will exhibit a vicat softening point in the 60-90 degrees C. range based on ASTM D1525. The seal layer may include 95 wt. % to 5 wt. % of the second plastomer, preferably 90 to 15 wt. %, or 80 to 25 wt. %.

Examples of this second component could be a variety of polyolefin plastomers such as Dow's AFFINITY SQ1503UE, PF1162G, PT1450G1, or PT1451G1, among many.

Certain additives are useful in modifying properties other than sealing properties of the peelable blend. Examples of some of the properties which can be modified are coefficient of friction, resistance to blocking, UV stability, thermal stability and color. Diatomaceous earth or silica may be added in the amount of 1,000 parts per million (ppm) to 10,000 ppm to add microscopic surface roughness which prevents sticking or “blocking” when the co-extruded blend side (layer 1) is wound against the opposite side in a roll. Fatty amides such as oleamide or erucamide may be added to modify the coefficient of friction of the material. The amount added is dependent on the coefficient of friction desired, the co-extrusion structure, lamination structure and co-extrusion thickness. In general, the amount of fatty amide required is 100 ppm to 2000 ppm.

These sealant blends can be processed in various manners, preferably extruded by cast or blown techniques.

These blends can be processed by extrusion coating at melt temperatures between 200-300 degrees C., more preferably between 250-280 degrees C. They can be incorporated in a monolayer or a coextruded layer, whichever best fits the extrusion coating equipment. The total thickness of this seal layer should be between 10-100 microns, preferably between 15-75 microns.

The base film onto which this seal layer is applied onto can be a commercially available polyester film such as Toray Plastics PA10. The base film thickness should be between 9-75 microns, preferably between 9-50 microns. The base layer provides structural integrity of the film and support for the other layers. In some embodiments, the base layer may include predominantly a thermoplastic polymer such as semi-crystalline homopolymer polyethylene terephthalate or polyethylene terephthalate copolymer or a biopolymer such as polylactic acid. The base layer may also optionally include organic or inorganic particulates for various purposes, such as to facilitate winding and handling of the film, or to enhance the mechanical and optical properties of the film, including reduction of the density of the film via cavitation. Representative examples of such particulate additives that may be added to the base layer include amorphous silica, calcium carbonate, clay, talc, diatomaceous earth, cross-linked spherical polymers such as poly(dimethylsiloxane), glass beads or mixtures of two or more of these. Moreover, to reduce material costs the base layer can optionally include a filler or extender component, such as regrinded recycled layer or film composition, or other polymeric compositions having suitably compatible processing and physical properties.

The base layer may be stretched in one or two orthogonal directions, i.e., for mono- or biaxial orientation. This treatment provides greater strength for the layer, and thus also for the overall film. It also permits the film to be produced to a thinner cross section dimension.

The resulting lidding article may be sealed onto rigid substrates such as frozen trays made of a variety of polymers such as polypropylene, polyester, coated paperboard, and coated aluminum. The sealing mechanism may be driven by temperature, pressure and contact time. The frozen trays and lidding film are usually sealed with drum sealers or platen sealers at speeds that vary from a few trays per minute to several hundred per minute.

This invention will be better understood with reference to the following examples, which are intended to illustrate specific embodiments within the overall scope of the invention.

### EXAMPLES

The following examples show how this particular invention provides a lower seal initiation temperature as compared to other traditional lidding films.

### Example 1

A heat seal layer with a thickness of 80 ga was formed from a blend of Dow Affinity® PT1450G1 and Dow Affinity® EG8200G as described herein. This heat seal blend was applied to Toray Plastics PA10 with a thickness of 48 ga. The film was made by extrusion coating the sealant blend onto the biaxially oriented polyester film layer.

### Comparative Example 1

Comparative Example 1 is a lidding film made by Toray Plastics under the name 272XL5. It is a 36 ga Toray Plastics PA10 polyester film layer with a 56 ga ethyl vinyl acetate (EVA) seal layer. The film was made by extrusion coating the sealant blend onto the biaxially oriented polyester film layer.

### Comparative Example 2

Comparative Example 2 is a lidding film made by Toray Plastics under the name 206XL5. It is a 48 ga Toray Plastics PA 10 polyester film layer with a 70 ga EVA seal layer. The film was made by extrusion coating the sealant blend onto the biaxially oriented polyester film layer.

### Comparative Example 3

Comparative Example 3 is a test sample made of 48 ga Toray Plastics PA10 polyester base film layer with a 56 ga EVA sealant layer. The film was made by extrusion coating the sealant blend onto the biaxially oriented polyester film layer.

Heat seals were made with a laboratory flat steel bar (1″×12″) sealer (Sentinel sealer, Sencorp) at 30 psi, with a 0.5 second dwell at various temperatures in degrees ° F. The seals were made to a polypropylene tray. Prior to peeling, the heat sealed material was cut into 1″ wide strips so that the film sample could be gripped in separate jaws of the tensile tester in a 180 degree configuration. The two jaws were separated at a rate of 12 in per minute and the average as well as the maximum force was recorded across the 1 inch seal width. The results of these tests are shown in the following Table 1.

TABLE 1

| Example | Value (lbs/in) | 250 F. | | | 275 F. | | | 300 F. | | | 325 F. | | |
|---|---|---|---|---|---|---|---|---|---|---|---|---|---|
| Ex. 1 | Max | 1.96 | 2.01 | 1.90 | 2.30 | 2.03 | 2.39 | 2.65 | 2.73 | 2.84 | 3.56 | 3.19 | 3.34 |
| | Curve Avg | 1.61 | 1.55 | 1.54 | 1.68 | 1.49 | 1.96 | 1.65 | 2.34 | 2.11 | 2.78 | 2.15 | 2.95 |
| Comp. | Max | 0.23 | 0.12 | 0.26 | 0.29 | 0.56 | 0.63 | 0.89 | 0.69 | 0.90 | 1.34 | 1.26 | 1.33 |
| Ex. 1 | Curve Avg | 0.16 | 0.07 | 0.15 | 0.17 | 0.45 | 0.35 | 0.71 | 0.46 | 0.72 | 1.10 | 1.04 | 1.12 |
| Comp. | Max | 0.32 | 0.74 | 0.71 | 1.01 | 0.95 | 1.04 | 1.17 | 1.14 | 1.28 | 1.19 | 1.39 | 1.33 |
| Ex. 2 | Curve Avg | 0.11 | 0.52 | 0.39 | 0.78 | 0.64 | 0.85 | 0.96 | 0.80 | 1.05 | 0.94 | 0.96 | 1.10 |
| Comp. | Max | 0.06 | 0.11 | 0.12 | 0.21 | 0.69 | 0.64 | 0.86 | 1.09 | 1.04 | 1.44 | 1.26 | 1.40 |
| Ex. 3 | Curve Avg | 0.03 | 0.08 | 0.08 | 0.13 | 0.43 | 0.53 | 0.60 | 0.93 | 0.83 | 1.14 | 1.03 | 1.13 |
| Example | Value (lbs/in) | 350 F. | | | 375 F. | | | 400 F. | | | 425 F. | | |
| Ex. 1 | Max | 3.98 | 3.19 | 3.75 | 4.59 | 4.19 | 4.79 | 4.36 | 4.53 | 7.24 | 4.78 | 5.07 | 6.45 |
| | Curve Avg | 3.30 | 2.11 | 3.23 | 3.82 | 3.27 | 3.89 | 3.23 | 3.83 | 4.59 | 3.96 | 4.47 | 4.32 |
| Comp. | Max | 1.58 | 1.58 | 1.65 | 1.66 | 1.80 | 1.62 | 1.71 | 1.80 | 1.69 | 1.78 | 1.67 | 1.84 |
| Ex. 1 | Curve Avg | 1.23 | 1.33 | 1.37 | 1.29 | 1.57 | 1.39 | 1.50 | 1.45 | 0.14 | 1.52 | 1.54 | 1.59 |
| Comp. | Max | 1.26 | 1.43 | 1.60 | 1.21 | 1.45 | 1.33 | 1.38 | 1.95 | 1.82 | 1.60 | 1.30 | 1.72 |
| Ex. 2 | Curve Avg | 0.96 | 1.02 | 1.17 | 0.95 | 1.23 | 1.10 | 1.16 | 1.52 | 1.32 | 1.33 | 1.08 | 1.34 |
| Comp. | Max | 1.70 | 1.51 | 1.76 | 2.05 | 2.06 | 2.28 | 2.28 | 2.19 | 2.43 | 2.89 | 2.24 | 2.43 |
| Ex. 3 | Curve Avg | 1.48 | 1.22 | 1.54 | 1.55 | 1.71 | 1.89 | 1.79 | 1.90 | 2.07 | 2.02 | 1.94 | 2.04 |

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

1. A method of making a lidding film comprising:
extruding a heat sealable and peelable layer comprising 5 to 95 wt % of a first polyolefin based plastomer or elastomer and from 5 to 95 wt % of a second plastomer or elastomer onto a polyester base layer to form a lidding film, wherein the second plastomer or elastomer has a different density and melt index than the first polyolefin based plastomer or elastomer.

2. The method of claim 1, wherein the heat sealable and peelable layer and the base layer are coextruded.

3. The method of claim 1, wherein the heat sealable and peelable layer is extrusion coated onto a preformed base layer.

4. The method of claim 3, wherein the heat sealable and peelable layer is extrusion coated onto the preformed base layer at a melt temperature between 225-350° C.

5. The method of claim 1, wherein the film has a seal strength of 1-3 lbs/, measured at 275° F., 30 psia, and 0.5 seconds dwell, when sealed to polypropylene or crystalline polyester trays.

6. The method of claim 1, wherein the thickness of the heat sealable and peelable layer is between 2-100 microns.

7. The method of claim 1, wherein the first polyolefin based plastomer or elastomer is a polyolefin-based plastomer with a density of between 0.84 and 0.91 gm/cubic cm based on ASTM D792 and a melt index between 3 and 10 gm/10 min, based on ASTM D1238.

8. The method of claim 1, wherein the first polyolefin based plastomer or elastomer has a vicat softening point of 40-60 degree C. based on ASTM D1525.

9. The method of claim 1, wherein the second polyolefin based plastomer or elastomer has a density of between 0.880 and 0.92 gm/cubic cm based on ASTM D792 and a melt index between 6 and 10 gm/10 min based on ASTM D1238.

10. The method of claim 1, wherein the second propylene based plastomer or elastomer has a vicat softening point of 60-90° C. based on ASTM D1525.

11. The method of claim 1, wherein the base layer has a thickness of 9-75 microns.

12. The method of claim 1, wherein the base layer is biaxially oriented.
